(19) United States
(12) Patent Application Publication
(10) Pub. No.: US 2015/0262322 A1
(43) Pub. Date: Sep. 17, 2015

(54) RENDERING OF GRAPHICS ON A DISPLAY DEVICE

(71) Applicant: Samsung Electronics Co., Ltd., Gyeonggi-do (KR)

(72) Inventor: Nigel Cardozo, Wokingham (GB)

(21) Appl. No.: 14/656,434

(22) Filed: Mar. 12, 2015

(30) Foreign Application Priority Data
Mar. 12, 2014 (GB) 1404381.4

(51) Int. Cl. G06T 1/20

(52) U.S. Cl. CPC G06T 1/20; G06T 2200/28

(57) ABSTRACT

A method of rendering an image using first and second processing units, wherein rendering the image comprises processing an object forming instruction and an object drawing instruction, includes determining whether the object drawing instruction comprises a first instruction for calling an execution of a second instruction on the second processing unit, processing the object forming instruction to obtain an object drawing information, storing the object drawing information, and deferring the execution of the first instruction when at least one of conditions is not satisfied, the conditions comprising the object drawing instruction comprises an object property instruction for changing a property of the stored object drawing information since the last execution of the first instruction and/or changing a property of an object forming instruction to be executed after the first instruction, or the number of times the first instruction since the last execution of the first instruction exceeds a value.

### CROSS-REFERENCE TO RELATED APPLICATION AND CLAIM OF PRIORITY

The present application is related to and claims the benefit under 35 U.S.C. §119(a) an United Kingdom patent application filed on Mar. 12, 2014 in the United Kingdom Intellectual Property Office and assigned Serial No. GB1404381.4, the entire disclosure of which is hereby incorporated by reference.

### TECHNICAL FIELD

The present disclosure concerns a method of rendering an image and/or graphics on a display device, and/or an apparatus or a system for performing the steps of the method thereof.

### BACKGROUND

Embodiments of the disclosure find particular, but not exclusive, use when the rendering of the image comprises steps including forming an object, which is then drawn on a virtual canvas. The drawn rendered image on the virtual canvas is then displayed on a screen for a viewer. An example of such rendering of an image is drawing an image on to a screen/displaying device using a canvas element of Hyper Text Markup Language, HTML5. HTML5 renders two dimensional shapes and bitmap images by defining a path in the canvas element, i.e. forming an object, and then drawing the defined path, i.e. drawing the object, onto the screen.

Conventionally, the object forming tends to be processed using general purpose software and/or hardware, whereas the object drawing tends to require specialized software and/or hardware to achieve an optimal image rendering performance. However, use of this specialized software and/or hardware can also lead to longer image rendering time.

### SUMMARY

To address the above-discussed deficiencies, it is a primary object to provide a method, an apparatus or a system for rendering an image on a display device.

According to the present disclosure, there is provided a method, an apparatus and a system as set forth in the appended claims. Other features of the disclosure will be apparent form the dependent claims, and the description which follows.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 shows a flowchart for a method of rendering an image according to a first embodiment of the present disclosure;

FIG. 2 shows a flowchart for a method of rendering an image according to a second embodiment of the present disclosure;

FIG. 3 shows a flowchart for a method of rendering an image according to a third embodiment of the present disclosure;

FIG. 4 shows a flowchart for a method of rendering an image according to a fourth embodiment which combines the second and third embodiments of the present disclosure;

FIG. 5 shows a system for rendering an image according to a fifth embodiment of the present disclosure;

FIG. 6 shows a system for rendering an image according to a sixth embodiment of the present disclosure;

FIG. 7 shows a system for rendering an image according to a seventh embodiment of the present disclosure; and

FIG. 8 shows a system for rendering an image according to an eighth embodiment of the present disclosure.

### DETAILED DESCRIPTION

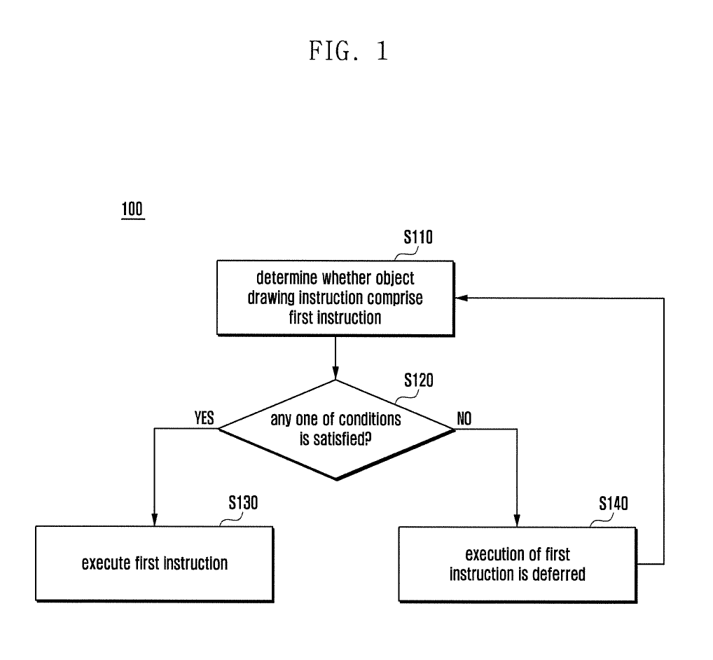

FIGS. 1 through 8, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged image and/or graphics rendering technologies.

FIG. 1 shows a method 100 of rendering an image according to a first embodiment of the disclosure. The method 100 uses a first processing unit and a second processing unit, wherein rendering the image comprises processing an object forming instruction and an object drawing instruction.

The first processing unit and the second processing unit can be physically separate processing units or virtually separate processing units. When the first processing unit and the second processing unit are virtually separate processing units, they are defined by functions they serve, for example by which type of instructions are processed by the processing units and/or what kind of resources are required for the processing on the processing units. Therefore, according to an embodiment of the disclosure, both first and second virtual processing units can perform processing functions thereof on a single physical processing unit.

Rendering an image comprises forming an object for the image and drawing the formed object on a virtual canvas for the image. Executing an object forming instruction forms and/or defines the object for the image, and generates object drawing information. The object drawing information is then used to draw the object on the virtual canvas. Depending on the actual implementation, the virtual canvas can be a frame for displaying on a display unit and the object drawing information can be data comprising pixel positions and color of each pixel to display the formed object on the display unit.

When a first instruction portion of an object drawing instruction is processed and/or executed, the first instruction calls for an execution of a second instruction. The second instruction obtains the generated object drawing information and draws the object on the virtual canvas. The first processing unit processes and/or executes the first instruction and the second processing unit processes and/or executes the second instruction.

The rendering of the image comprises both processing the first instruction portion on the first processing unit and the second instruction on the second processing unit. For the embodiments described herein, the second processing unit is assumed to be specialized software and/or hardware which require a significant processing time to process the second instruction and/or an initialization before the processing of the second instruction. Such an initialization can then lead to an increased processing time for the rendering of the image every time a second instruction is communicated to the second processing unit for processing and/or execution.

By deferring the execution of the first instruction wherever possible, it is possible to improve an overall image rendering time by processing and/or executing the second instruction for rendering the image only when it is necessary. Also, by deferring the execution of the first instruction, it is possible to batch a plurality of the first instructions and/or consequences of processing/executing the plurality of the first instructions (such as calling a processing/execution of second instructions) so that the processing/executing the batch can be performed at one go so that processing/execution time on the second processing unit is minimized. By processing/executing the second instruction only when it is necessary and/or by batching the plurality of the first instruction and/or consequences of processing/executing thereof, the embodiments described herein enable an efficient rendering of an image.

By reducing the number of times the second processing unit is initialized for processing/executing the second instruction through batching of the plurality of the first instructions and/or consequences of processing/executing the first instructions, by reducing the number of times the second instruction is called and/or by reducing the number of times the second instruction is processed and/or executed, the contribution to the overall rendering time from the processing time required for the processing of the second instruction is minimized so that the overall rendering time of the image is reduced and/or minimized.

An object finalizing instruction indicates the forming of a specific object for the image is completed and the object can now be drawn on the virtual canvas. So the processing and/or execution of the object finalizing instructions are, in general, followed by processing and/or execution of the object drawing instruction.

An object property instruction is a type of an object drawing instruction. The object property instruction sets a property related to how the object is drawn in the virtual canvas. For example, the object property instruction can set the color of each pixel the object occupies and/or the number of pixels a part of the object is to occupy and so on. Since such object property instruction can change a property of an object, which is formed/defined by the object drawing information, the object drawing information comprises property information for setting a property of the object.

So when the object property instruction for changing property information is processed and/or executed, drawing of an object formed/defined by already generated object drawing information must first take place if the second instruction only supports drawing of a single object at a time according to already available object drawing information. To simplify the embodiment described herein, this limitation on the second instruction is assumed in the following embodiments.

It is understood that the embodiments described herein can also be implemented even when the second instruction supports drawing of more than one object at a time according to already available object drawing information for each object, for example by generating and/or grouping the object drawing information obtained from processing/executing the object property instruction and storing the obtained object drawing information for each object so that later processing/execution of the second instruction can take place with correct property information for each object.

According to the first embodiment, when an instruction is received/read by the first processing unit, the method 100 commences.

If the received/read instruction is an object drawing instruction, at step S110 (a first determination step), the method 100 determines whether the object drawing instruction comprises a first instruction for calling an execution of a second instruction on the second processing unit, and/or whether the object drawing instruction comprises an object property instruction.

If the received/read instruction is an object forming instruction and/or the object drawing instruction not comprising the first instruction or the object property instruction, the first processing unit processes the object forming instruction to obtain an object drawing information, and/or processes the object drawing instruction. As more than one object forming instructions and/or object drawing instructions are processed, the object drawing information generated from processing of each object forming instruction and/or object drawing instruction is appended to the previously generated object drawing information.

At step S110, if the first processing unit determines the object drawing instruction to comprise the first instruction for calling the execution of the second instruction on the second processing unit, the method 100 adds one to a counter for counting a number of times the first instruction is determined, and performs a first assessment step (S120) for assessing whether any one of the conditions set out at step S120 is satisfied.

Suitably, if the first processing unit determines the object drawing instruction to comprise the first instruction for calling the execution of the second instruction on the second processing unit, the method 100 performs an alternative step for counting the number of times the first instruction is determined, and then performs the first assessment step (S120).

Suitably, if the first processing unit determines the object drawing instruction to comprise the first instruction for calling the execution of the second instruction on the second processing unit, the method 100 proceeds to performing the first assessment step (S120) if the number of times the first instruction is determined is not to be used in step (b) of the first assessment step (S120).

Suitably, if the first processing unit determines the object drawing instruction to comprise an object property instruction, the method 100 performs a first assessment step (S120) for assessing whether any one of the conditions set out at step S120 is satisfied. This step is useful if when the object property instruction for changing property information is processed and/or executed, drawing of an object formed/defined by already generated object drawing information can first take place.

At step S120, the method 100 comprises a step of assessing at least one of the following conditions:

(a) if the object drawing instruction comprises an object property instruction for changing a property of the stored object drawing information since the last execution of the first instruction and/or changing a property of an object forming instruction to be executed after the first instruction;

(b) if the number of times the first instruction is determined by the first processing unit since the last execution of the first instruction exceeds a predetermined value; or

(c) if a predetermined amount of time has passed since the last execution of the first instruction.

If at least one of the conditions (a), (b), and (c) in step S120 is satisfied, the method 100 performs step S130, i.e. executes the first instruction or the deferred first instruction if there is one. The counter for counting the number of times the first instruction is determined and/or a timer for timing amount of time passed since the last execution of the first instruction are/is also reset.

Suitably, if condition (a) in step S120 is satisfied, and the object property instruction is for changing a property of the stored object drawing information, at step S130 the property of the stored object drawing information is changed and then the deferred first instruction is executed with the changed object drawing information. This step is useful if the second instruction only supports drawing of a single object at a time according to already available object drawing information.

Suitably, if condition (a) in step S120 is satisfied, and the object property instruction is for changing a property of an object forming instruction to be executed after the first instruction, the deferred first instruction is executed and then the object property instruction is executed so that the changed property is stored for the next execution of the first instruction. This step is useful if the second instruction only supports drawing of a single object at a time according to already available object drawing information.

If none of the conditions (a)-(c) is satisfied, the method 100 performs step S140.

At step S140, the execution of the first instruction is deferred and the method 100 proceeds to the first determination step S110 to perform determining on the next instruction received/read.

Suitably, a portion of the object drawing instruction which is not a first instruction for calling a second instruction and/or which is not an object property instruction, is processed and/or executed. Suitably, the object drawing information is also stored and/or appended to previously stored object drawing information.

Suitably, at step S140, if the object drawing instruction does not comprise an object property instruction, the object drawing information is stored and/or appended to previously stored object drawing information, the execution of the first instruction deferred, and the method 100 proceeds to the first determination step S110 to perform determining on the next instruction received/read.

Suitably, at step S140, if the object drawing instruction comprises an object property instruction, which is determined by condition (a) to be not an object property instruction for changing a property of the stored object drawing information since the last execution of the first instruction and/or changing a property of an object forming instruction to be executed after the first instruction, the object drawing information is stored, the object drawing instruction is ignored, and the method 100 proceeds to the first determination step S110. This step is useful in preventing repetitive processing/execution of object drawing instructions which do not change the property of the stored object drawing information and/or of the object forming instruction to be executed after the first instruction.

Alternatively, any subset and/or combination thereof of the conditions (a)-(c) can be assessed in step S120. For example, according to an alternative embodiment, only one of the conditions (a)-(c) is assessed at step S120. According to an alternative embodiment, any two conditions from the conditions (a)-(c) are assessed at step S120.

According to yet another embodiment, the first assessment step (S120) assesses the conditions as being satisfied if at least two of the three conditions (a)-(c) are satisfied. According to another embodiment, the first assessment step (S120) assesses the conditions as being satisfied only if all three conditions (a)-(c) are satisfied.

It is understood that if the first instruction is executed, the second instruction is executed on the second processing unit using the object drawing information obtained by the first processing unit.

It is also understood that the processing of the second instruction and/or initialising of required resources for an execution on the second processing unit, such as function libraries or registers/cache/memories, requires time (a second processing time) which is a significant portion of an overall image rendering time needed to render the image. The overall image rendering time can comprise a first processing time of the object forming and object drawing instructions on the first processing unit, and the second processing time of the second instruction on the second processing unit.

Since an image is likely to comprise more than one object, the overall rendering time of the image is more likely to comprise an overall first processing time of all the object forming/drawing instructions of all the objects of the image on the first processing unit and an overall second processing time of all the second instructions of all the objects of the image on the second processing unit.

The overall second processing time can be longer than the overall first processing time. By deferring the execution of the first instruction, the first embodiment of the present disclosure enables the second processing unit to process the second instruction for rendering the image only when the first assessment step S120 assesses it to be required (at least one of the conditions (a)-(c) satisfied), whereby the overall second processing time can be reduced and/or minimized.

By reducing the number of times the second instruction is called and/or by reducing the number of times the second instruction is processed by the second processing unit, the contribution to the overall rendering time from the processing time required for the processing of the second instruction in the second processing unit is minimized so that the overall image rendering time of the image is reduced and/or minimized.

Also, by reducing the number of times initializing of required resources for an execution on the second processing unit is required in rendering the image. By deferring the execution of the first instruction wherever possible and storing/updating/appending the relevant object drawing information, it is possible to batch a plurality of the first instructions and/or consequences of processing/executing the plurality of the first instructions so that the processing/executing the batch can be performed at one go. This minimizes the processing/execution time on the second processing unit.

By processing/executing the second instruction only when it is necessary and/or by batching the plurality of the first instruction and/or consequences of processing/executing thereof, the embodiments described herein enable an efficient rendering of the image.

By reducing the number of times the second processing unit is initialized for processing/executing the second instruction through batching of the plurality of the first instructions and/or consequences of processing/executing the first instructions, by reducing the number of times the second instruction is called and/or by reducing the number of times the second instruction is processed and/or executed, the contribution to the overall rendering time from the processing time required for the processing of the second instruction is minimized so that the overall rendering time of the image is reduced and/or minimized.

When a user views the rendered image on a display unit, the reduced/minimized overall image rendering time enables a faster refresh rate on the display unit so that smoother image transition can be viewed on the display unit. This is particularly advantageous when the user views a moving picture comprising a plurality of images.

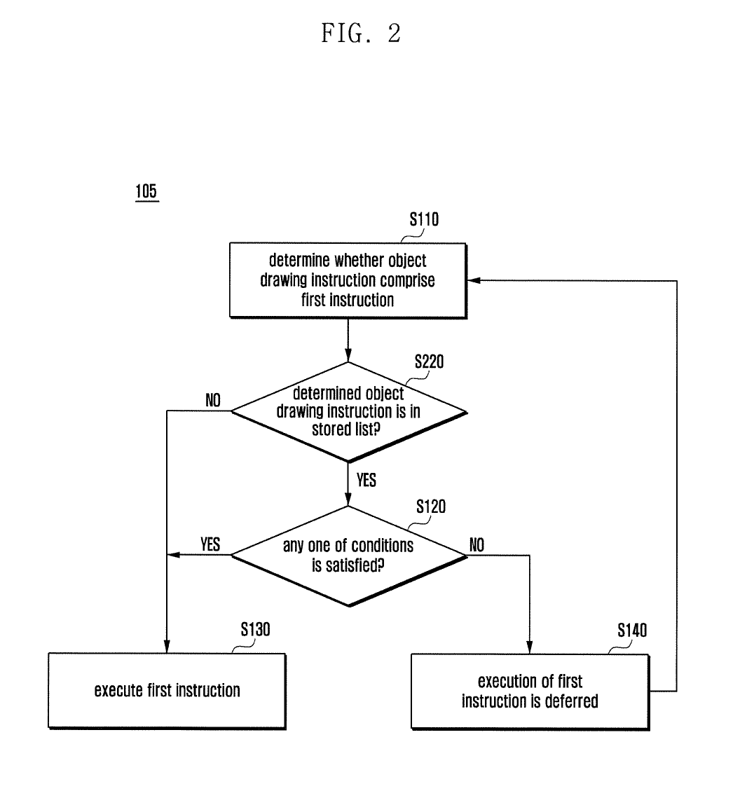

FIG. 2 shows a method 105 of rendering an image according to a second embodiment of the disclosure, which comprises a second assessment step S220.

The method 105 according to the second embodiment comprises steps of storing a list of at least one object drawing instruction, and performing the same steps described in relation to FIG. 1 with the additional second assessment step S220.

At step S220, the method 105 assesses whether the determined object drawing instruction (determined at the first determination step S110) is in the stored list. If the determined object drawing instruction is not in the stored list, the method 105 proceeds to step S130 and executes the deferred first instruction if there is any. If the determined object drawing instruction is in the stored list, the method 105 proceeds to the first assessment step S120.

The list comprises at least one object drawing instruction so that the method 105 according to first embodiment of the disclosure can be implemented on the object drawing instruction identified in the list. Alternatively, the list can be an exclusion list so that if the determined object drawing instruction is not in the stored list, the method 105 proceeds to the first assessment step S120 and if the determined object drawing instruction is in the stored list, the method 105 proceeds to step S130.

The second assessment step S220, in effect, works as an enable switch so that according to the method 105 of the second embodiment, the method 100 of the first embodiment is only applied when the determined object drawing instruction of the first determination step S110 is in the stored list.

It is understood that a number of variations for enabling and/or switching on/off the method 100 of the first embodiment can be implemented according to an embodiment of the disclosure. For example, the second assessment step S220 can be performed after the first assessment step S120 and before the step S140. Additionally and/or alternatively, a flag instead of a list can be used.

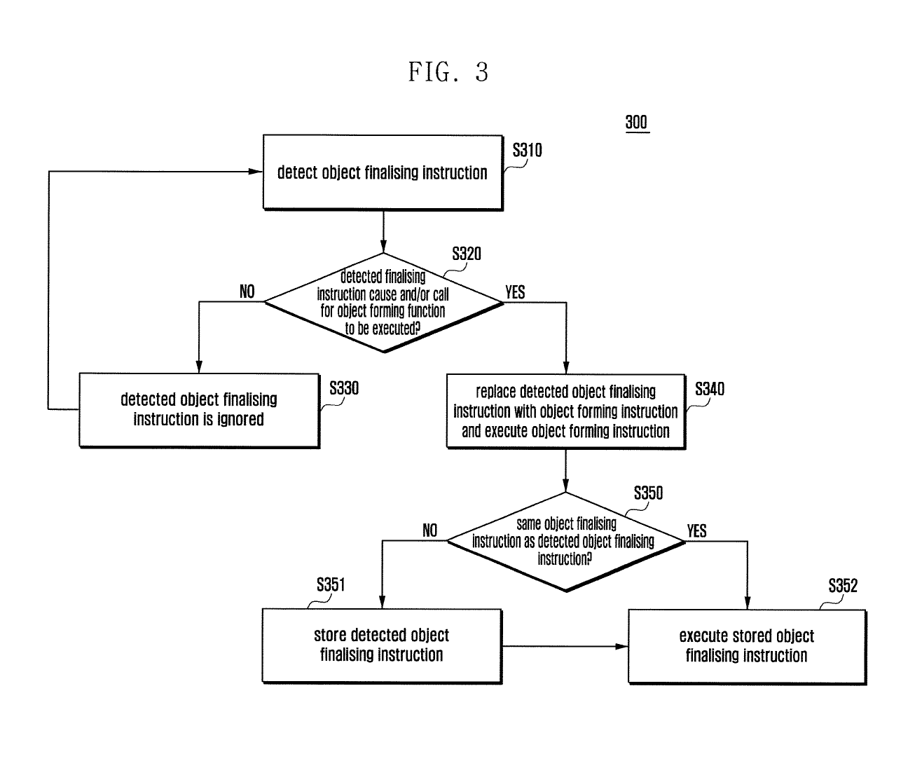

FIG. 3 shows a method 300 of rendering an image according to a third embodiment of the disclosure. The method 300 comprises processing an object finalizing instruction after an execution of a first instruction has been deferred according to the first and/or second embodiment 100, 105. Although not limited thereto, this method 300 is particularly useful if the second instruction only supports drawing of a single object at a time according to already available object drawing information since an object finalizing instruction indicates forming of a specific object for the image is completed and an execution of an object drawing instruction generally follows the execution of the object finalizing instruction. Processing an object finalizing instruction comprises the following steps.

Step S310 is a detection step comprising detecting an object finalizing instruction. If an object finalizing instruction is detected, the method 300 proceeds to step S320. If an object finalizing instruction is not detected, the method 300 executes the received/read instruction.

Step S320 is a second determination step for determining whether the detected finalizing instruction causes and/or calls for an object forming function to be executed. If the detected finalizing instruction causes and/or calls for an object forming function to be executed, proceed to step S340. If the detected finalizing instruction does not cause and/or call for an object forming function to be executed, proceed to step S330.

This step S320 is useful since some object finalizing instructions comprise, cause and/or call an object forming function to be executed before indicating completion of forming of a specific object. This enables a final stage for forming the specific object to be performed by processing/executing the relevant object finalizing instruction rather than having to process/execute another separate object forming function and/or instruction.

At step S330, the detected object finalizing instruction is ignored and the method 300 proceeds to detecting the next object finalizing instruction at step S310. According to an embodiment, at step S330, the detected object finalizing instruction is stored. According to an alternative embodiment, if an object forming instruction can be used to form an object in the image even after an execution of the detected object finalizing instruction, the detected object finalizing instruction is executed at step S330.

It is understood that the step S330 can also comprise a conditional performing of the ignoring, storing and/or executing step mentioned above. For example, if the detected object finalizing instruction allows further forming/defining of the present object even after the execution of the detected object finalizing instruction, and the detected object finalizing instruction is detected for the first time since the last execution of a first instruction, the detected object finalizing instruction is executed and its execution flagged up at step S330. If the detected object finalizing instruction has been detected before (since the last execution of a first instruction), the detected object finalizing instruction is ignored or stored, and the method moves on to receiving/reading the next instruction. When a first instruction is executed the flag is reset so that between every successive executions of the first instruction, the same object finalizing instruction is executed only once at the outset.

At step S340, if the detected finalizing instruction causes and/or calls for an object forming function to be executed, the method 300 performs: replacing the detected object finalizing instruction with an object forming instruction which causes and/or calls for an execution of the same and/or equivalent object forming function; executing the object forming instruction instead of the detected object finalizing instruction; and proceeding to step S350. It is understood that as the same and/or equivalent object forming function, an object forming function resulting in the same object and/or shape in the rendered image is sufficient.

The replacing of the detected object finalizing instruction is useful since if the second instruction only supports drawing of a single object at a time according to already available object drawing information, completion of forming the specific object must be deferred for the processing/execution of the second instruction to be deferred and/or batched.

Step S350 is a third determination step for determining whether the same object finalizing instruction as the detected object finalizing instruction (detected at step S310) has already been stored since the last execution of the first instruction. A flag and/or a list of stored object finalizing instruction can be used to make this determination.

If the same object finalizing instruction has not been stored since the last execution of the first instruction, the method 300 proceeds to step S351 and stores the detected object finalizing instruction, before proceeding to step S352.

If the same object finalizing instruction has been stored since the last execution of the first instruction, the method 300 proceeds to step S352.

At step S352, when the deferred first instruction is executed, the method 300 executes the stored object finalizing instruction before executing the deferred first instruction.

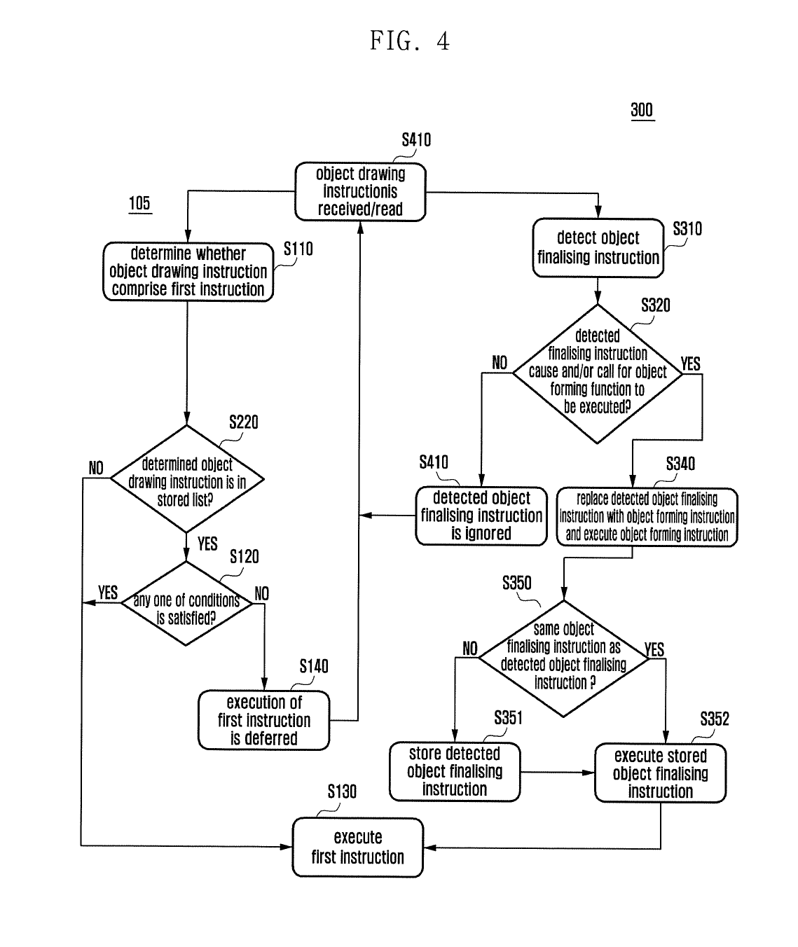

FIG. 4 shows a method of rendering an image according to a fourth embodiment which combines the second 105 and third 300 embodiments of the disclosure.

At step S410, an instruction is received and/or read at the first processing unit. If the received and/or read instruction is an object drawing instruction, the method proceeds to the first determination step S110 of the second embodiment 105 and proceeds accordingly. If the received and/or read instruction is an object finalizing instruction, the method proceeds to the object finalizing instruction detection step S310 of the third embodiment 300 and proceeds accordingly.

If the determined object drawing instruction is not in the stored list according to the second assessment step S220, the condition of the first assessment step S120 is satisfied, or the stored object finalizing instruction has been executed according to step S352, the method proceeds to step S130 so that the first instruction is executed.

The step S410 is a prior step to the steps S110 and S310, and also replaces the steps S110 and S310 as a subsequent step to the steps S140 and S330 of the second and third embodiment respectively.

According to the method of the fourth embodiment, the second embodiment 105 is implemented so that a first instruction of an object drawing instruction is executed only when the conditions of the first and second assessment steps S120, S220 are appropriately assessed, and the third embodiment 300 is implemented so that certain types of an object finalizing instruction is only executed just before the execution of the first instruction.

Since such types of the object finalizing instruction prevent execution of further object forming instructions, the third embodiment 300 ensures object finalizing instruction with an equivalent function as an object forming instruction/function are replaced with the functionally equivalent object forming instruction/function so that the execution of such types of objection finalizing instruction can be deferred until the first instruction is executed. This enables as much of the object forming/definition from the object forming instruction/function can take place before the execution of the first instruction.

By reducing the number of times the execution of the first instruction is required in rendering an image, the fourth embodiment reduces the overall image rendering time.

According to an exemplary embodiment of the present disclosure, the method of the fourth embodiment is implemented using the canvas element of Hyper Text Markup Language, HTML5. The exemplary embodiment below is described based on HTML Canvas 2D Context, Level 2, W3C Working Draft 29 Oct. 2013, published online at “http://www.w3.org/TR/2dcontext2/” by the World Wide Web Consortium, W3C. The exemplary embodiment is also implemented using the Open Graphics Library, OpenGL, which is a cross-language, multi-platform application programming interface, API, for rendering 2D and 3D graphics. The OpenGL API is typically used to interact with a Graphics processing unit (GPU), to achieve hardware-accelerated rendering.

It is understood that any one of the four embodiments described herein can also be implemented using the canvas element of HTML5, HTML5 API and OpenGL API, but since the fourth embodiment comprises most of the features described in relation to all the four embodiments, only the implementation of the fourth embodiment is described in detail.

It is understood that the actual implementation of the exemplary embodiment can vary depending on how a top layer, i.e. an application programming interface or API, and a bottom layer, i.e. a platform on which the API is based, are defined. Depending on the definition of the top and the bottom layers, the actual implementation of the present disclosure can vary to accommodate different groupings of instructions, functions and/or commands in accordance with the definition within the top and bottom layers. For example, an instruction which is defined as an object drawing instruction under a first set of top and bottom layers can be defined as an object property instruction under a second set of top and bottom layers.

It is also understood that the fourth embodiment can further comprise a method step of storing an indicator which acts as a switch for enabling or disabling the implementation of the fourth embodiment when an instruction is processed by a processing unit, e.g. first or second processing unit.

According to an exemplary embodiment, the object forming instruction processes image data for rendering the image, for example object drawing information comprising position data, as elements in an array data and the second instruction comprises an OpenGL function for rendering geometric primitives from the array data. Preferably, the second instruction comprises at least one of glDrawArrays or glDrawElements OpenGL function.

According to an exemplary embodiment:

the object forming instruction or the object forming function comprises at least one of a moveTo( ) or lineTo( ) function for defining a path (i.e. for generating coordinate or position data for the path);

the object drawing information comprises at least one of property data or position data for the path;

the object drawing instruction comprises at least one of stroke( ) function, fill( ) function, or the object property instruction; and

the object property instruction comprises at least one of strokeStyle( ), strokeWidth( ), lineWidth( ), lineColor( ), or lineCap( ) function.

Suitably, the object forming instruction or the object forming function comprises at least one path and/or subpath defining functions such as quadraticCurveTo( ), bezierCurveTo( ), arcTo( ), arc( ), ellipse( ), rect( ) etc. Suitably, the object forming instruction or the object forming function comprises at least one path objects for editing paths such as addPath( ), addText( ) etc. Suitably, the object forming instruction or the object forming function comprises at least one transformation functions for performing transformation on text, shapes or path objects. Such transformation functions comprises scale( ), rotate( ), translate( ), transform( ), setTransform( ) etc. for applying a transformation matrix to coordinates (i.e. position data of the object drawing information) to create current default paths (transformed position data of the object drawing information).

Suitably, the object property instruction comprises at least one of: line style related functions (e.g. lineCap( ), lineJoin( ), miterLimit( ), setLineDash( ), lineDashOffset( ) etc.); text style related functions (e.g. font( ), textAlign( ), textBaseline( ) etc.); or fill or stroke style functions (e.g. fillStyle( ), strokeStyle( ) etc.).

Suitably, the object drawing instruction comprises at least one path objects of stroking variant such as addPathByStrokingPath( ) or addPathByStrokingText( ). Suitably, the object drawing instruction comprises at least one of the aforementioned object property instructions.

Suitably, the object finalizing instruction comprises at least one of openPath( ) or closePath( ) function.

Consider rendering an image comprising a plurality of rectangles in a web browser environment using HTML5. With the purpose of simplifying the description of this particular embodiment:

the object forming instructions or the object forming functions are moveTo( ), lineTo( ), and translate( ) functions for defining a path;
the object drawing information includes the coordinate (position data) and color for the path;

the object drawing instructions are stroke( ) function, fill( ) function, and the object property instructions;

the object property instructions are strokeStyle( ), strokeWidth( ), lineWidth( ), and lineCap( ) functions; and

the object finalizing instructions are beginPath( ) and closePath( ) functions.

The function beginPath( ) does not cause an execution of an object forming function and the function closePath( ) causes an execution of an object forming function. The execution of the object forming function performs equivalent function as executing lineTo( ) function with parameters for the original starting point of the path.

The second instructions are glDrawArrays and glDrawElements OpenGL functions and the stroke( ) and strokeStyle( ) instructions call an execution of at least one of these second instructions.

It is understood that according to another exemplary embodiment, only the stroke( ) instruction can call an execution of at least one of these second instructions.

The list of object drawing instructions stored for the second assessment step S220 includes stroke( ) and strokeStyle( ) functions.

The predetermined value for use with the condition (b) of the first assessment step S120 is 100 and the predetermined amount of time for use with the condition (c) of the first assessment step S120 is 100 seconds. It is understood that different predetermined value and amount of time can be used according to a particular embodiment of the disclosure. It is also understood that depending on the actual implementation, optimal values for the predetermined value and amount of time can be determined using practice runs of a specific length of HTML5 code for rendering an image.

Firstly, a function “drawPath( )” is defined to form an object, i.e. a first rectangle with vertices at coordinates (0,0), (100,0), (100,100), and (0, 100):

function drawPath( ) {
g.strokeStyle = “black”;
g.beginPath( );
g.moveTo(0,0);
g.lineTo(100,0);
g.lineTo(100,100);
g.lineTo(0,100);
g.closePath( );
g.stroke( );
}

It is assumed that an overall rectangle processing time of rendering the first rectangle using the drawPath( ) function is 1 second. The first processing time is 0.3 seconds and the second processing time is 0.7 seconds (for rendering two second instructions called by g.strokeStyle( ) and g.stroke( )).

In order to form the image comprising a plurality of the rectangles, the function “drawPath( )” could be repeated with different coordinate parameters (position data). Since stroke( ) and strokeStyle( ) functions are object drawing instructions comprising a first instruction for calling a second instruction (e.g. glDrawArrays or glDrawElements), each repetition of the function “drawPath( )” will call the second instruction which can lead to large overall image rendering time owing to increased overall second processing time which is cumulated from the second processing times of the repeated execution of the second instructions. For example, the overall image rendering time can be n times 1 second if n rectangles are present in the image. Therefore, if the number of the execution of the second instruction for rending the image is reduced, for each reduction in the number of execution of the second instruction, 0.7/2=0.35 seconds of the overall image rendering time can be saved.

If the fourth embodiment is implemented when the first rectangle of the image is rendered, at step S410 the instructions of the function drawPath( ) are received/read and the method determines that no object drawing instruction (e.g. g.stroke( )) was deferred previously.

At step S410, the received/read g.strokeStyle( ) is recognised as an object drawing instruction and the method proceeds to the first determination step S110. At the first determination step S110, g.storkeStyle( ) is recognised as comprising a first instruction for calling a second instruction (glDrawArrays or glDrawElements OpenGL function) and the method proceeds to the second assessment step S220. At the second assessment step S220, g.strokeStyle( ) is assessed as being included in the list of object drawing instructions stored for the second assessment step S220, and the method proceeds to the first assessment step S120.

At the first assessment step S120, g.strokeStyle( ) is assessed to be an object property instruction for changing a property since g.strokeStyle( ) changes the style to “black” ((a) satisfied), the number of times the first instruction is determined since the last execution is not 100 yet since this is the first time ((b) not satisfied), and the predetermined amount of time has not passed yet since the overall rectangle processing time is 1 second ((c) not satisfied). Therefore, the first assessment step S120 assesses condition (a) to be satisfied and proceeds to step S130.

At step S130, g.strokeStyle( ) is executed with the style parameter “black” stored so that the stored parameter can be compared with a parameter of the next object property instruction so that whether the next object property instruction changes the property (i.e. the parameter) or not can be assessed. The method than proceeds to receiving/reading the next instruction of the function drawPath( ).

If at step S130, it is determined that g.stroke( ) function had been deferred before, the deferred g.stroke( ) is executed first and then g.strokeStyle( ) is executed.

At step S410, the received/read g.beginPath( ) is recognised as an object finalizing instruction and the method proceeds to the detection step S310. At the detection step S310, g.beginPath( ) is detected as an object finalizing instruction and the method proceeds to the second determination step S320.

At the second determination step S320, g.beginPath( ) is determined to not cause an execution of an object forming function and the method proceeds to step S330.

At step S330, the detected g.beginPath( ) is determined to have been detected for the first time since the last execution of a first instruction. The detected g.beginPath( ) is also determined to allow further forming/defining of the present path even after the execution of g.beginPath( ). So g.beginPath( ) is executed and a flag for indicating that g.beginPath( ) function has been executed since the last execution of a first instruction is set. The method then proceeds to receiving/reading the next instruction (step S410).

Subsequent object forming instructions g.moveTo( ) and g.lineTo( ) are received/read and executed as normal since they are neither an object drawing instruction or an object finalizing instruction. The execution of the object forming instruction generates object drawing information such as position data for defining a path (e.g. coordinates). The generated object drawing information is appended to previously stored object drawing information and stored. The generated object drawing information can then be used by an object drawing instruction (e.g. g.stroke( )) when calling the execution of a second instruction for rendering the image comprising the plurality of rectangles. When the next object finalizing instruction g.closePath( ) is encountered at step S410, the method proceeds to the detection step S310 and the second determination step S320 as described in relation to g.beginPath( ).

At the second determination step S320, since g.closePath( ) causes the object (path) to close (equivalent to g.lineTo(0,0)), the determination step S320 proceeds to S340. At step S340, g.closePath( ) is replaced with g.lineTo(0,0) which is then executed, and the method proceeds to the third determination step S350. Since no object finalizing instruction (g.closePath( )) was stored since the last execution of a first instruction because this is the first rectangle, the method proceeds to step S351 to store g.closePath( ), after which it proceeds to step S352 so that the stored g.closePath( ) is executed just before the next execution of the deferred first instruction. The method then proceeds to receiving/reading the next instruction at step S410.

At step S410, an object drawing instruction (g.stroke( )) is received/read. The method proceeds to the first determination step S110 and recognises that g.stroke( ) comprises a call to a second instruction such as glDrawArrays or glDrawElements OpenGL function, and proceeds to the second assessment step S220. At the second assessment step S220, g.stroke( ) is assessed as being included in the list of object drawing instructions and the method proceeds to the first assessment step S120.

The first assessment step S120 assesses the conditions (a)-(c) and determines all the conditions (a)-(c) to be not satisfied and proceeds to the step S140. At step S140, g.stroke( ) is stored and execution of g.stroke( ) comprising the first instruction is deferred. The method proceeds to receiving/reading the next instruction.

Up to this point, by implementing the fourth embodiment, g.closePath( ) has been replaced with g.lineTo( ) and the execution of g.stroke( ) has been deferred till later so the overall processing time saved is only the processing time of the second instruction called by g.stroke( ) and any difference from replacing g.closePath( ) with g.lineTo( ).

In order to render an image comprising a plurality of rectangles, which can have different sizes, orientations and/or coordinates, a number of different ways can be used to render further rectangles onto the image. As a simple example, let us assume the image comprises a plurality of rectangles of the same size as the rectangle of drawPath( ) but positioned at different coordinates.

To render the image comprising the plurality of the rectangles, the same drawPath( ) function can manually be repeated or a function repeatPath( ) for automating forming of a plurality of same objects (rectangles) can be used to achieve the same effect as manual repetition to render the image comprising the plurality of the objects (rectangles):

function repeatPath( ) {
for (i=0; i<1000; i++) {
g.translate((10*i),(10*i));
g.strokeStyle = “black”;
g.beginPath( );
g.moveTo(0,0);
g.lineTo(100,0);
g.lineTo(100,100);
g.lineTo(0,100);
g.closePath( );
g.stroke( );
}
}

Another function for automating the forming of a plurality of same objects (rectangles) might be transformPath( ) which utilises already defined “drawPath( )” function to automate the forming of a plurality of same objects (rectangles):

```
function transformPath( ) {
  can = document.getElementById(“can”);
  g = can.getContext(“2d”);
  for (i=0; i<1000; i++) {
    g.translate((10*i),(10*i));
    drawPath( );
  }
  }
```

Both functions repeatPath( ) and transformPath( ) define a loop from i=0 to i=999 with parameter i increasing by an increment of 1 after each loop. After each loop, a rectangle is translated by (10*i) and (10*i), and formed on the image.

Without the fourth embodiment implemented, at each loop g.strokeStyle( ) and g.stroke( ) will call a second instruction (glDrawArrays or glDrawElements OpenGL function) which results in 2000 calls for all the loop from i=0 to i=999. This adds a significant overall second processing time of at least 700 seconds (1000×the second processing time of g.strokeStyle( ) and g.stroke( ) which is 0.7 seconds) to the overall image rendering time.

If the fourth embodiment is implemented, g.translate( ) will be executed as normal since it is an object forming instruction.

However, for all the loops where i=1 to at least i=49, g.strokeStyle( ), which is an object drawing instruction and an object property instruction, will not satisfy any of the conditions (a)-(c) of the first assessment step S120 since it is not an object finalizing instruction which changes the style parameter from the stored “black” to another parameter value ((a) not satisfied), the number times the first instruction is determined is at maximum 99 ((b) not satisfied), and the overall processing time up to that point is less than 50 seconds which is 50 times the processing time of one drawPath( ) function ((c) not satisfied). Therefore, the method proceeds to step S140.

At step S140, the parameter value “black” (object drawing information) is stored. The method proceeds to receiving/reading the next instruction at step S410. According to an alternative embodiment, at step S140 if no change is made to the stored object drawing information, no storing takes place and the method proceeds to step S410. Since the execution of g.strokeStyle( ) does not take place for the loops where i=1 to at least i=49, at least 49 executions of second instructions called by the execution of g.strokeStyle( ) are not performed leading to saving of 49×0.7/2=17.15 seconds of overall second processing time.

When g.stroke( ) is received at step S410, the similar steps as g.strokeStyle( ) take place for loops where i=1 to at least i=49 since g.stroke( ) does not comprise an object property instruction ((a) not satisfied) and (b)-(c) are also not satisfied. At step S140, the object drawing information is stored and the execution of g.stroke( ) is deferred. Therefore, whilst processing the loops where i=1 to at least i=49, the overall second processing time of the overall image rendering time is reduced by 2×17.15=34.3 seconds.

It is understood that, for this particular embodiment, if the predetermined amount of time and number of times the first instruction is determined is increased to a large value, even more second processing time can be saved but this may not be the case in other embodiments.

When condition (b) or (c) of the first assessment step S120 is satisfied, g.stroke( ) is executed at step S130 and the count or timer is reset. For at least subsequent 49 loops from the last execution of g.stroke( ), similar overall second processing time savings can be achieved so that during the rendering of the whole image comprising the plurality of rectangles, a significant total overall second processing time can be saved.

Therefore, the fourth embodiment of the present disclosure improves an overall image rendering time of an image comprising a plurality of rectangles in a web browser environment using HTML5 by a significant amount. The present disclosure is particularly more advantageous when a number of repeated shapes and/or objects, or transformation of a shape and/or object are used in forming and/or defining the image. Further, when a large number of object drawing instructions are encountered during the repetition and/or transformation of the shape and/or object, the present disclosure offers a significant improvement on the overall image rendering time by reducing and/or minimising the execution of the encountered object drawing instructions.

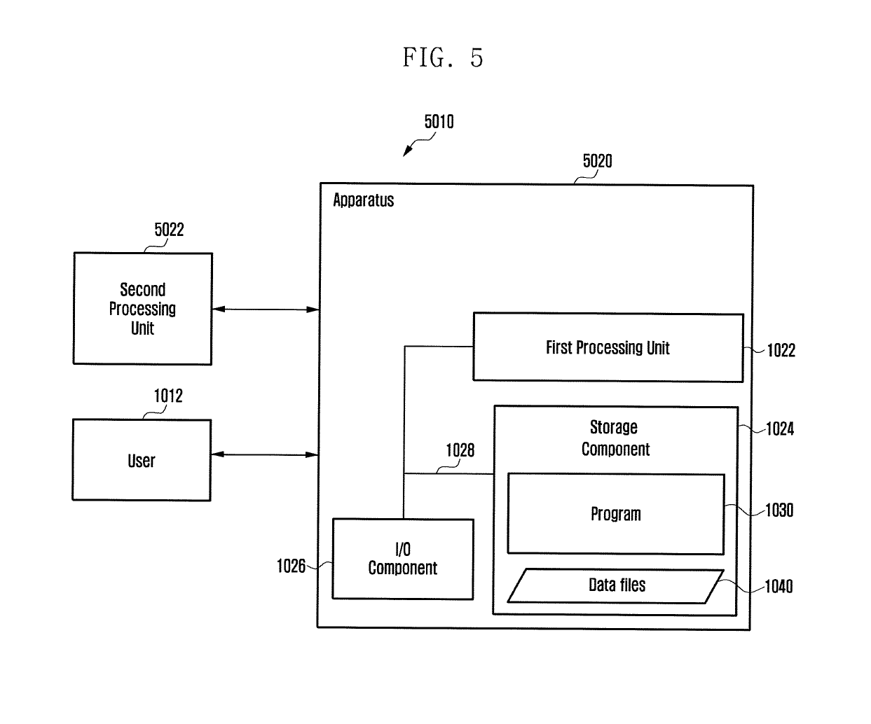

According to an embodiment of the present disclosure a system for rendering an image is provided. Exemplary embodiments of the system 5010, 6010, 7010, 8010 are shown in FIGS. 5-8.

When rendering of the image comprises processing a first instruction which call for an execution of a second instruction and if the processing of the second instruction and/or initialising of required resources for the execution on the second instruction, such as function libraries or registers/cache/memories, requires time (a second processing time), an overall image rendering time of the system 5010, 6010, 7010, 8010 can be improved by reducing the second processing time. This, in turn, leads to improved image rendering performance of the system 5010, 6010, 7010, 8010.

According to an exemplary embodiment, rendering of the image comprises processing an object forming instruction, an object forming function, an object drawing information, an object drawing instruction, the first instruction, an object property instruction, an object finalizing instruction, and/or the second instruction as described in relation to foregoing embodiments. Suitably, the system 5010, 6010, 7010, 8010 processes instructions based on HTML5 Application Programming Interface, HTML5 API.

The overall rendering time of the image comprises a first processing time of the object forming and object drawing instructions, and the second processing time of the second instruction.

Since an image is likely to comprise more than one object, the overall rendering time of the image is more likely to comprises an overall first processing time of all the object forming and object drawing instructions of all the objects of the image and an overall second processing time of all the second instructions of all the objects of the image.

The overall second processing time can be longer than the overall first processing time. By deferring the execution of the first instruction wherever possible, it is possible to improve the overall image rendering time by processing and/or executing the second instruction for rendering the image only when it is necessary. Also, by deferring the execution of the first instruction, it is possible to batch a plurality of the first instructions and/or consequences of processing/executing the plurality of the first instructions so that processing/executing the batch at one go is possible, as described in relation to foregoing embodiments and the first assessment step S120 of those embodiments. This reduces the processing time on the second processing unit. By processing/executing the second instruction only when it is necessary and/or by batching the plurality of the first instructions and/or consequences of processing/executing thereof, the foregoing embodiments enable an efficient rendering of an image.

By reducing the number of times the second processing unit is initialised for processing/executing a second instruction through batching of the plurality of the first instructions, by reducing the number of times the second instruction is called and/or by reducing the number of times the second instruction is processed and/or executed, the contribution to the overall rendering time from the processing time required for the processing of the second instruction is minimised so that the overall rendering time of the image is reduced and/or minimised.

When a user views the rendered image on a display unit of the system 5010, 6010, 7010, 8010, the reduced/minimised overall image rendering time enables faster refresh/frame rate on the display unit so that smoother image transition can be viewed on the display unit. This is particularly advantageous when the user views a moving picture comprising a plurality of images.

FIGS. 5-8 show illustrative environments according to a fifth, a sixth, a seventh, or an eight embodiment 5010, 6010, 7010, 8010 of the disclosure. The skilled person will realise and understand that embodiments of the present disclosure can be implemented using any suitable computer system, and the example apparatuses and/or systems shown in FIGS. 5-8 are exemplary only and provided for the purposes of completeness only. To this extent, embodiments 5010, 6010, 7010, 8010 include an apparatus and/or a computer system 5020, 6020, 7020, 8020 that can perform a method and/or process described herein in order to perform an embodiment of the disclosure. In particular, an apparatus and/or a computer system 5020, 6020, 7020, 8020 is shown including a program 1030, which makes apparatus and/or computer system 5020, 6020, 7020, 8020 operable to implement an embodiment of the disclosure by performing a process described herein.

Apparatus and/or computer system 5020, 6020, 7020, 8020 is shown including a first processing unit 1022 or a processing unit 8052 (e.g., one or more processors), a storage component 1024 (e.g., a storage hierarchy), an input/output (I/O) component 1026 (e.g., one or more I/O interfaces and/or devices), and a communications pathway (e.g., a bus) 1028. In general, first processing unit 1022 or processing unit 8052 executes program code, such as program 1030, which is at least partially fixed in storage component 1024. While executing program code, first processing unit 1022 or processing unit 8052 can process data, which can result in reading and/or writing transformed data from/to storage component 1024 and/or I/O component 1026 for further processing. Pathway (bus) 1028 provides a communications link between each of the components in apparatus and/or computer system 5020, 6020, 7020, 8020. I/O component 1026 can comprise one or more human I/O devices, which enable a human user 1012 to interact with apparatus and/or computer system 5020, 6020, 7020, 8020 and/or one or more communications devices to enable an apparatus/system user 1012 to communicate with apparatus and/or computer systems 5020, 6020, 7020, 8020 using any type of communications link. To this extent, program 1030 can manage a set of interfaces (e.g., graphical user interface(s), application program interface, and/or the like) that enable human and/or apparatus/system users 1012 to interact with program 1030. Further, program 1030 can manage (e.g., store, retrieve, create, manipulate, organize, present, etc.) the data, such as a plurality of data files 1040, using any solution.

In any event, apparatus and/or computer system 5020, 6020, 7020, 8020 can comprise one or more general purpose computing articles of manufacture (e.g., computing devices) capable of executing program code, such as program 1030, installed thereon. As used herein, it is understood that “program code” means any collection of instructions, in any language, code or notation, that cause a computing device having an information processing capability to perform a particular action either directly or after any combination of the following: (a) conversion to another language, code or notation; (b) reproduction in a different material form; and/or (c) decompression. To this extent, program 1030 can be embodied as any combination of system software and/or application software.

Further, program 1030 can be implemented using a set of modules. In this case, a module can enable apparatus and/or computer system 5020, 6020, 7020, 8020 to perform a set of tasks used by program 1030, and can be separately developed and/or implemented apart from other portions of program 1030. As used herein, the term “component” means any configuration of hardware, with or without software, which implements the functionality described in conjunction therewith using any solution, while the term “module” means program code that enables an apparatus and/or computer system 5020, 6020, 7020, 8020 to implement the actions described in conjunction therewith using any solution. When fixed in a storage component 1024 of an apparatus and/or computer system 5020, 6020, 7020, 8020 that includes a first processing unit 1022 or a processing unit 8052, a module is a substantial portion of a component that implements the actions. Regardless, it is understood that two or more components, modules, and/or systems can share some/all of their respective hardware and/or software. Further, it is understood that some of the functionality discussed herein may not be implemented or additional functionality can be included as part of apparatus and/or computer system 5020, 6020, 7020, 8020.

When apparatus and/or computer system 5020, 6020, 7020, 8020 comprises multiple computing devices, each computing device can have only a portion of program 1030 fixed thereon (e.g., one or more modules). However, it is understood that apparatus and/or computer system 5020, 6020, 7020, 8020 and program 1030 are only representative of various possible equivalent apparatuses and/or computer systems that can perform a process described herein. To this extent, in other embodiments, the functionality provided by apparatus and/or computer system 5020, 6020, 7020, 8020 and program 1030 can be at least partially implemented by one or more computing devices that include any combination of general and/or specific purpose hardware with or without program code. In each embodiment, the hardware and program code, if included, can be created using standard engineering and programming techniques, respectively.

Regardless, when apparatus and/or computer system 5020, 6020, 7020, 8020 includes multiple computing devices, the computing devices can communicate over any type of communications link. Further, while performing a process described herein, apparatus and/or computer system 5020, 6020, 7020, 8020 can communicate with one or more other apparatuses and/or computer systems using any type of communications link. In either case, the communications link can comprise any combination of various types of optical fiber, wired, and/or wireless links; comprise any combination of one or more types of networks; and/or utilize any combination of various types of transmission techniques and protocols.

In any event, apparatus and/or computer system 5020, 6020, 7020, 8020 can obtain data from files 1040 using any solution. For example, apparatus and/or computer system 5020, 6020, 7020, 8020 can generate and/or be used to generate data files 1040, retrieve data from files 1040, which can be stored in one or more data stores, receive data from files 1040 from another system, and/or the like.

According to the fifth, sixth or seventh embodiment, the system 5010, 6010, 7010 comprises a first processing unit 1022, a storage 1024, and a second processing unit 5022, 6022, 7022 wherein: the first processing unit 1022 is operable to process an object forming instruction and an object drawing instruction and, if the first processing unit 1022 determines the object drawing instruction comprises a first instruction for calling an execution of a second instruction on the second processing unit 5022, 6022, 7022, the first processing unit 1022 is configured to process the object forming instruction to obtain an object drawing information, and to store the object drawing information in the storage 1024, and to defer the execution of the first instruction unless:

(a) the first instruction comprises an object property instruction for changing a property of the stored object drawing information since the last execution of the first instruction and/or changing a property of an object forming instruction to be executed after the first instruction;

(b) the number of times the first instruction is determined by the first processing unit 1022 since the last execution of the first instruction exceeds a predetermined value; or

(c) a predetermined amount of time has passed since the last execution of the first instruction.

Suitably, the first processing unit 1022 is configured to store a list of at least one object drawing instruction in the storage 1024, and, if the determined object drawing instruction is not in the stored list, to execute the first instruction.

Suitably, the rendering of the image further comprises the first processing unit 1022 processing an object finalizing instruction and the first processing unit 1022 is configured to:

detect the object finalizing instruction;

if the detected finalizing instruction causes an object forming function to be executed, replace the detected object finalizing instruction with an object forming instruction which causes an execution of the object forming function and execute the object &liming instruction instead of the detected object finalizing instruction;

store the object finalizing instruction in the storage 1024 if the same object finalizing instruction was not stored since the last execution of the first instruction; and

when the deferred first instruction is executed, execute the stored object finalizing instruction before the deferred first instruction.

According to an exemplary embodiment, the first processing unit 1022 comprises a Central Processing Unit and each second processing unit 5022, 6022, 7022 comprises a Graphics Processing Unit connected to a display unit for displaying the rendered image.

FIG. 5 shows a system 5010 for rendering an image according to the fifth embodiment of the present disclosure comprising the second processing unit 5022 and an apparatus 5020.

A user 1012 inputs a command to operate the apparatus 5020 and/or the second processing unit 5022. The user 1012 also views a displayed image, which has been rendered by the apparatus 5020 and the second processing unit 5022, on a display unit.

It is understood that the user 1012 can input the commands via a wireless communication channel or via a panel connected to the apparatus 5020, the second processing unit 5022 and/or the display unit 6012.

The display unit can be a part of the apparatus 5020 so that it is communicable via a bus 1028 of the apparatus 5020, or can be a separate display unit in communication with the apparatus 5020 or the second processing unit 5022, so that the rendered image can be displayed by the display unit.

Suitably, the apparatus is a mobile device 5020 and the second processing unit 5022 is a part of a separate component which can be communicably connected to the mobile device 5020 to provide an image rendering capability. The display unit is in communication with at least one of the mobile device 5020 or the separate component so that the rendered image can be displayed by the display unit.

Suitably, the apparatus is a mobile device 5020 and the second processing unit 5022 is a part of a display device which can be communicably connected to the mobile device 5020 to provide an image rendering capability. The display device then displays the rendered image.

Suitably, the apparatus is a display device 5020 and the second processing unit 5022 is a part of a separate component which can be communicably connected to the display device 5020 to provide an image rendering capability. The display unit is located on the display device 5020 so that the rendered image can be displayed thereon.

It is understood that other variants of a separate component comprising the second processing unit 5022, and an apparatus 5020 in communication with the separate component are possible according to the fifth embodiment.

Since the second processing unit 5022 is a part of the separate component, and thus likely to use a communication channel which has slower data transfer rate than the bus 1028 of the apparatus 5020, it is likely that communicating image drawing information and/or any other data for processing and/or executing the second instruction on the second processing unit 5022 will involve a significant amount of second processing time. Therefore, the system 5010 provides an improved image rendering performance by reducing the number of times the second instruction is processed and/or executed when rendering the image.

According to following sixth, seventh and eight embodiments, the display unit 6012 can be a part of the apparatus 6020, 7020, 8020 so that it is communicable via a bus 1028 of the apparatus 6020, 7020, 8020, or can be a separate display unit 6012 in communication with the apparatus 6020, 7020, 8020, so that the rendered image can be displayed by the display unit 6012. Additionally and/or alternatively the user 1012 can input a command to operate the display unit 6012 to the display unit 6012 directly and/or via the apparatus 6020, 7020, 8020.

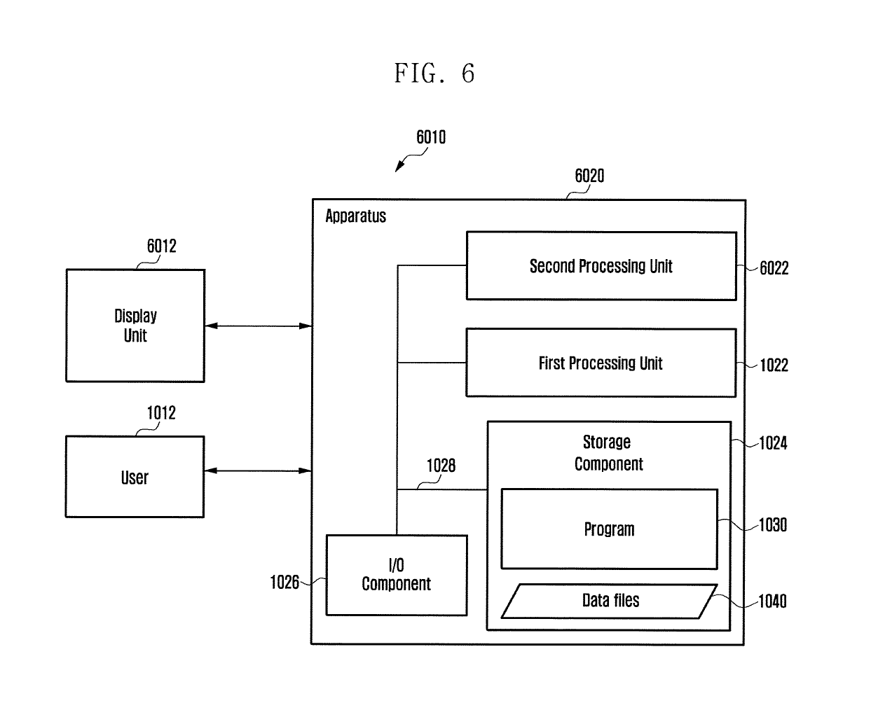

FIG. 6 shows a system 6010 for rendering an image according to the sixth embodiment of the present disclosure comprising a display unit 6012 and an apparatus 6020.

The system 6010 comprises many common features with the system 5010 according to the fifth embodiment. However, according to the sixth embodiment, the second processing unit 6022 is located in the apparatus 6020 so that the second processing unit 6022 is in communication with the first processing unit 1022 via the bus 1028 of the apparatus 6020.

In contrast to the fifth embodiment, the first processing unit 1022 and the second processing unit 6022 are in communication via the bus 1028 so that no further time delays due to slower communication channel are present. However, it is still possible to reduce the overall image rendering time by reducing the number of times the second instruction is processed and/or executed on the second processing unit 6022.

Suitably, the first processing unit 1022 and the second processing unit 6022 are installed on a single circuit board. Alternatively, the second processing unit 6022 is installed on a separate circuit board, such as a graphics card, which can then be installed onto a circuit board comprising the first processing unit 1022, such as a motherboard.

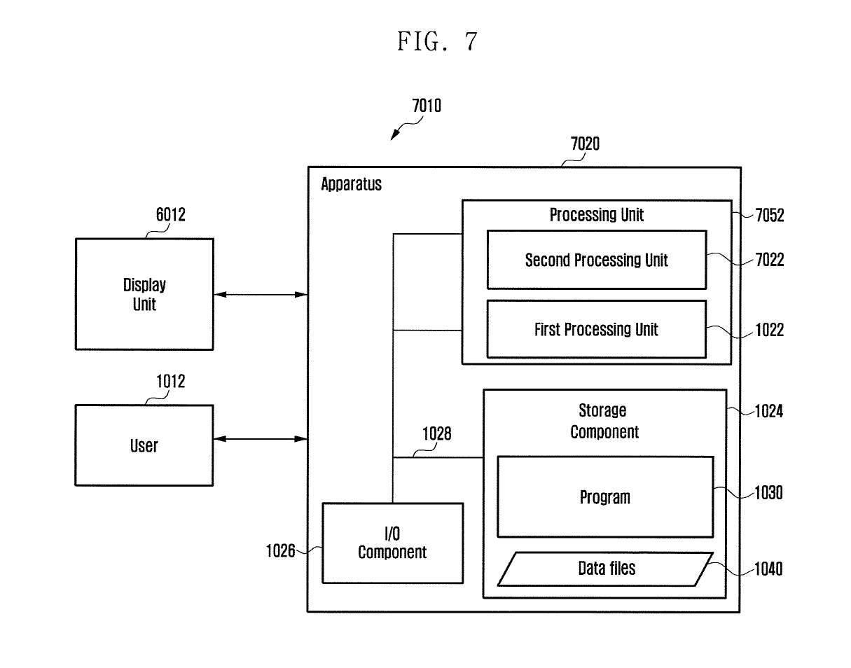

FIG. 7 shows a system 7010 for rendering an image according to the seventh embodiment of the present disclosure comprising a display unit 6012 and an apparatus 7020.

The system 7010 comprises many common features with the system 6010 according to the sixth embodiment. However, in contrast to the sixth embodiment, the first processing unit 1022 and the second processing unit 7022 are present in a single processing unit 7052.

Suitably, the processing unit 7052 is a central processing unit and the first/second processing unit 1022, 7022 comprises a core of the central processing unit.

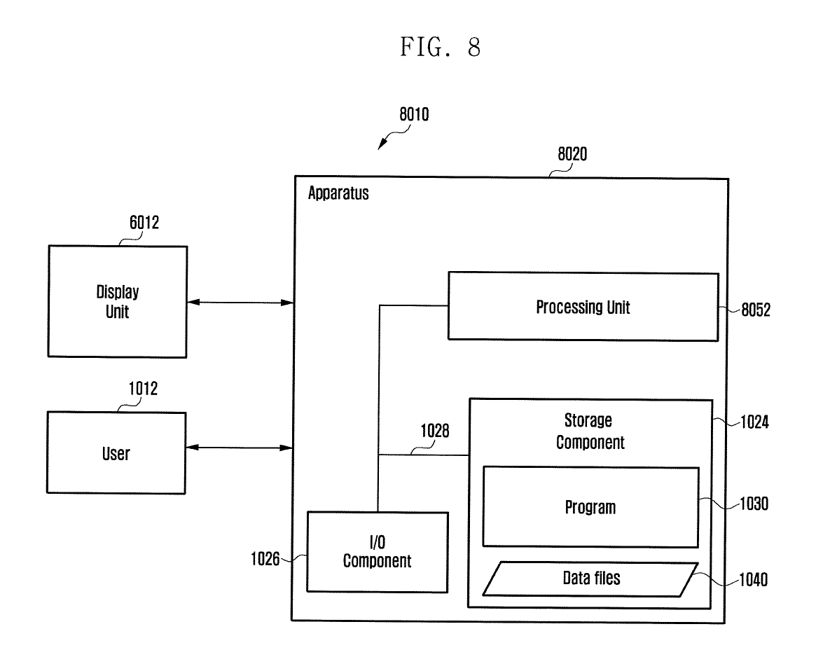

FIG. 8 shows a system 8010 for rendering an image according to the eighth embodiment of the present disclosure comprising a display unit 6012 and an apparatus 8020.

The system 8010 comprises many common features with the system 5010, 6010, 7010 according to the fifth embodiment, sixth embodiment and/or the seventh embodiment. However, according to the eighth embodiment, a single processing unit 8052 performs functions performed by both first processing unit 1022 and second processing unit 5022, 6022, 7022 of the system 5010, 6010, 7010 according to the fifth, sixth or seventh embodiment. By reducing the number of calls required to be performed on the second processing unit 5022, 6022, 7022 according to the fifth, sixth or seventh embodiment, the second processing time on the processing unit 8052 is also reduced, whereby the system 8010 provides for an improved image rendering performance.

It is understood that other combinations and/or variations of the exemplary embodiments shown in FIGS. 5-8 can also be provided according to an embodiment of the present disclosure.

It is understood that according to an exemplary embodiment, a computer readable medium storing a computer program to operate a method of rendering an image according to the foregoing embodiments is provided. Suitably, when the computer program is implemented, it intercepts a call to a second instruction and/or an object drawing or finalizing instruction to perform the method thereon.

It is understood that a display unit and/or display device is any device for displaying an image. It can be a screen comprising a display panel, a projector and/or any other device capable of displaying an image so that a viewer can view the displayed image.

It is understood that a first processing unit and a second processing unit can be virtual processing units which are divided by their functionalities and/or roles in the image rendering process. As described in relation to the seventh and eighth embodiments, a single physical central processing unit can perform all the functionalities and/or roles of both virtual processing units, namely the first processing unit and the second proceeding unit.

It is understood that any information, instruction and/or function can be stored using an identifier. In this case, the stored information, instruction and/or function is identified using the stored identifier, and a separate library and/or data is consulted so that the reading, execution and/or the consequential effect thereof of the identified stored information, instruction and/or function can be achieved using the stored identifier.

For example, storing an object forming instruction, an object drawing instruction and/or an object finalizing instruction comprises storing an identification information for identifying the object forming instruction, an object drawing instruction and/or an object finalizing instruction respectively. Additionally and/or alternatively, storing an object forming instruction, an object drawing instruction and/or an object finalizing instruction comprises storing the actual code representing the instruction and/or another code for invoking the instruction.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, can be combined in any combination, except combinations where at least some of such features and/or steps are mutually exclusive.

Each feature disclosed in this specification (including any accompanying claims, abstract and drawings) can be replaced by alternative features serving the same, equivalent or similar purpose, unless expressly stated otherwise. Thus, unless expressly stated otherwise, each feature disclosed is one example only of a generic series of equivalent or similar features.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method of rendering an image using a first processing unit, wherein rendering the image comprises processing an object forming instruction and an object drawing instruction, the method comprising:
determining whether the object drawing instruction comprises a first instruction for calling an execution of a second instruction on a second processing unit;
processing the object forming instruction to obtain an object drawing information;
storing the object drawing information; and
deferring the execution of the first instruction when at least one of conditions is not satisfied, the conditions comprising:
(a) the object drawing instruction comprises an object property instruction for changing a property of the stored object drawing information since a last execution of the first instruction and/or changing a property of an object forming instruction to be executed after the first instruction;
(b) the number of times the first instruction is determined by the first processing unit since the last execution of the first instruction exceeds a predetermined value; or
(c) a predetermined amount of time has passed since the last execution of the first instruction.

2. The method of claim 1, wherein the method further comprises storing a list of at least one object drawing instruction, and, if the determined object drawing instruction is not in the stored list, executing the first instruction.

3. The method of claim 1, wherein the rendering of the image further comprises processing an object finalizing instruction and the method further comprises:
detecting the object finalizing instruction;
if the detected finalizing instruction causes an object forming function to be executed, replacing the detected object finalizing instruction with an object forming instruction which causes an execution of the object forming function and executing the object forming instruction instead of the detected object finalizing instruction;
storing the object finalizing instruction if the same object finalizing instruction was not stored since the last execution of the first instruction; and
when the deferred first instruction is executed, executing the stored object finalizing instruction before the deferred first instruction.

4. The method of claim 1, wherein the object forming instruction is configured to process image data for rendering the image as elements in an array data and the second instruction comprises an OpenGL function for rendering geometric primitives from the array data.

5. The method of claim 1, wherein the method is implemented using HTML5 Application Programming Interface (HTML5 API).

6. The method of claim 5, wherein:
the object forming instruction or the object forming function comprises a moveTo( ) or lineTo( ) function for defining a path;
the object drawing information comprises position data for the path;
the object drawing instruction comprises stroke( ) function, fill( ) function, or the object property instruction comprising a strokeStyle( ), strokeWidth( ), lineWidth( ), or lineCap( ) function; and
the second instruction comprises glDrawArrays or glDrawElements OpenGL function.

7. The method of claim 6, wherein the object finalizing instruction comprises a openPath( ) or closePath( ) function.

8. The method of claim 1, wherein the first processing unit comprises a Central Processing Unit and the second processing unit comprises a Graphics Processing Unit connected to a display for displaying the rendered image.

9. A first processing unit for rendering an image, wherein the first processing unit is configured to:
process an object forming instruction and an object drawing instruction; and,
in response to determining that the object drawing instruction comprises a first instruction for calling an execution of a second instruction on a second processing unit:
process the object forming instruction to obtain an object drawing information, and
store the object drawing information in a storage, and
defer the execution of the first instruction when at least one of conditions is not satisfied, the conditions comprising:
(a) the object drawing instruction comprises an object property instruction for changing a property of the stored object drawing information since the last execution of the first instruction and/or changing a property of an object forming instruction to be executed after the first instruction;
(b) the number of times the first instruction is determined by the first processing unit since the last execution of the first instruction exceeds a predetermined value; or
(c) a predetermined amount of time has passed since the last execution of the first instruction.

10. The first processing unit of claim 9, wherein the first processing unit is configured to store a list of at least one object drawing instruction in the storage, and, if the determined object drawing instruction is not in the stored list, to execute the first instruction.

11. The first processing unit of claim 9, wherein the rendering of the image further comprises the first processing unit processing an object finalizing instruction and the first processing unit is configured to:
detect the object finalizing instruction;
if the detected finalizing instruction causes an object forming function to be executed, replace the detected object finalizing instruction with an object forming instruction which causes an execution of the object forming function and execute the object forming instruction instead of the detected object finalizing instruction;
store the object finalizing instruction in the storage if the same object finalizing instruction was not stored since the last execution of the first instruction; and
when the deferred first instruction is executed, execute the stored object finalizing instruction before the deferred first instruction.

12. The first processing unit of claim 9, wherein the object forming instruction is configured to process image data for rendering the image as elements in an array data, and the second instruction comprises an OpenGL function for rendering geometric primitives from the array data.

13. The first processing unit of claim 9, wherein the system is configured to process instructions based on HTML5 Application Programming Interface (HTML5 API).

14. The first processing unit of claim 13, wherein:
the object forming instruction or the object forming function comprises a moveTo( ) or lineTo( ) function for defining a path;
the object drawing information comprises position data for the path;
the object drawing instruction comprises stroke( ) function, a fill( ) function, or the object property instruction comprising a strokeStyle( ), strokeWidth( ), lineWidth( ), or lineCap( ) function; and
the second instruction comprises glDrawArrays or glDrawElements OpenGL function.

15. The first processing unit of claim 14, wherein the object finalizing instruction comprises a openPath( ) or closePath( ) function.

16. The first processing unit of claim 9, wherein the first processing unit comprises a Central Processing Unit and the second processing unit comprises a Graphics Processing Unit connected to a display for displaying the rendered image.

17. A non-transitory computer readable medium storing computer program-readable instructions that when executed by a processor, cause the processor to perform a method of rendering an image using a first processing unit, wherein rendering the image comprises processing an object forming instruction and an object drawing instruction, the method comprising:
determining whether the object drawing instruction comprises a first instruction for calling an execution of a second instruction on a second processing unit;
processing the object forming instruction to obtain an object drawing information;
storing the object drawing information; and
deferring the execution of the first instruction when at least one of conditions is not satisfied, the conditions comprising:
(a) the object drawing instruction comprises an object property instruction for changing a property of the stored object drawing information since a last execution of the first instruction and/or changing a property of an object forming instruction to be executed after the first instruction;
(b) the number of times the first instruction is determined by the first processing unit since the last execution of the first instruction exceeds a predetermined value; or
(c) a predetermined amount of time has passed since the last execution of the first instruction.

18. The non-transitory computer readable medium of claim 17, wherein the method further comprises storing a list of at least one object drawing instruction, and, if the determined object drawing instruction is not in the stored list, executing the first instruction.

19. The non-transitory computer readable medium of claim 17, wherein the rendering of the image further comprises processing an object finalizing instruction and the method further comprises:
detecting the object finalizing instruction;
if the detected finalizing instruction causes an object forming function to be executed, replacing the detected object finalizing instruction with an object forming instruction which causes an execution of the object forming function and executing the object forming instruction instead of the detected object finalizing instruction;
storing the object finalizing instruction if the same object finalizing instruction was not stored since the last execution of the first instruction; and
when the deferred first instruction is executed, executing the stored object finalizing instruction before the deferred first instruction.

20. The non-transitory computer readable medium of claim 17, wherein the object forming instruction is configured to process image data for rendering the image as elements in an array data and the second instruction comprises an OpenGL function for rendering geometric primitives from the array data.
